(19) United States
(12) Patent Application Publication
(10) Pub. No.: US 2022/0108186 A1
(43) Pub. Date: Apr. 7, 2022

(54) Niche Ranking Method

(71) Applicant: Francisco Daniel Filip Duarte, Oaxaca (MX)

(72) Inventor: Francisco Daniel Filip Duarte, Oaxaca (MX)

(21) Appl. No.: 17/478,400

(22) Filed: Sep. 17, 2021

Related U.S. Application Data
(60) Provisional application No. 63/086,954, filed on Oct. 2, 2020.

(51) Int. Cl. G06N 3/12

(52) U.S. Cl. CPC G06N 3/126

(57) ABSTRACT

This invention is a niching optimization algorithm that provides multiple extrapolated points of a function, the maximum or minimum outputs, over one optimization run. Yet differently than existing niching algorithms, it locally ranks each local population, providing a multi-focus exploration with an equalized number of solutions inside each niche, and identifies the set of most efficient and distinct solutions, instead of the overall population of solution. As an optimization algorithm, it has broad application in artificial intelligence, and in the design of engineering systems such as aeronautical structures, etc. . . . . It also can generate a mesh for any dataset or function domain, grouping inputs by regions of similitude. Thus, it can generate a mesh for a FEM, and segment the domain of expensive metamodels, like artificial neural networks, Kriging models (KR), among others. Experiments demonstrated that with a response surface mesh, the overall training time is substantially reduced.

### CROSS REFERENCES TO RELATED APPLICATIONS

This application claims the benefit of Applicants' prior provisional application named Local Optimum Ranking 2, application No. 63/086,954, filed on Oct. 2 2020.

### BACKGROUND OF THE INVENTION

### 1. Field of the Invention

Several engineering systems require very precise mathematical models which simulate their physical response, which work in conjunction with an optimization algorithm to find very efficient design variation. This is the design methodology presently applied in the industry related to systems and structures in the domains of space, aerospace, automotive, among others, which require elevated efficiency to be a competitive solution in the market. Also, another field that greatly relies on optimization algorithms for its usual operation is artificial intelligence (AI). A popular group of optimization algorithms is denominated global optimization algorithms (GOAs), which works with a population of solutions and recombines the best solutions to achieve efficient configurations. Niching methods or multimodal optimization algorithms (MMO) are algorithms that can be combined with GOAs in order to find multiple extrapolated outputs of a function over one optimization run, providing both efficiency and diversity for design tasks, in the case the best solution is not suitable for the task.

Yet a common problem of these MMO methods is that its output is the overall population of solutions, which generates a large workload to designers to verify which solution is the most suitable.

Another application of the NRM is the segmentation of response surfaces, which are the basic building blocks of AI. Since AI tasks often require large data set to train the metamodels, these metamodels become very complex and require expensive computation efforts.

### 2. Description of the Related Art

The genetic algorithm (GA) is a very popular GOA, which is inspired by the theory of evolution of living organisms reproduced by mating. It states that beneficial mutations tend to accumulate over time, thus generating its evolution. Goldberg [1] describes the functionality of the GA. Kennedy [2] described the method called particle swarm optimization (PSO), which is based on the flocking movement of birds and the schooling of fishes. Other GOAs which are also popular, is differential evolution [3], simulated annealing [4], and cuckoo search algorithm [5], among many others.

Niching optimization algorithms or MMO methods are algorithms that search for multiple extrapolated and distinct output of a function, since in engineering, one single solution for the design or an aerospace structure or the design of a nuclear plant heat exchanger, for example, may not be suitable.

In order to find multiple feasible solutions of a function, MMO algorithms or niching methods were created, which work in conjunction with GOAs. Some well-known niching algorithms are presented:
Fitness sharing (FS)—Created by Holland [6] and improved by Goldberg and Richardson [7], this algorithm mimics how living species compete for resources on nature, which favors its broader distribution on a given geographic region. In this algorithm, the fitness value is divided by a function that integrates the presence of other solutions within a niching radius.
Clearing method (C)—In this MMO algorithm, a number of the best solutions within a niching radius have their fitness preserved. Exceeding solutions have their fitness cleared.
Crowding with redistricted tournament selection (RTS)—Created by Harik in 1995 [8], in this method, a GOA has a population POP_P which generates POP_Q. A set of N solutions randomly chosen from POP_P is selected. A single solution of POP_Q competes with the closer solution of the set, and the best solution is kept in the next generation. This process is repeated to all solutions of POP_Q.
Deterministic Crowding (DC)—In a GOA which performs crossover operations, each offspring of the generated pair competes with the closest parent. The solution with the best fitness is kept for the next generation. This method was created in 1992 by Mahfoud [9]

De Jong introduced the concept of crowding methods [10] in 1975. Among other niching methods are derating [11], parallelization [12], and clustering [13].

Yet a common problem of the existing niching methods is that they provide all the population of solutions as the output, not identifying which solutions are the most efficient on each niche region of the domain.

Another problem is that these niching algorithms tend to distribute the population of solutions on the most promising regions of the domain, over-populating some niches and sub-populating others. Since a niche can present a poor outcome in the initial phases of the exploration, and a promising output after it is properly explored, these algorithms can present a poor performance in many optimization tasks.

In optimization, a metamodel, which is also called a response surface (RS) or surrogate model, can be applied to reduce computation costs. This is achieved by dismissing unpromising candidate solutions and suggesting promising alternatives. Among well-known RS are Kriging (KR) also called Gaussian process [14], polynomial regression [15], radial basis functions [16], and ANNs [17]. To evaluate the efficiency of a RS in forecasting the output of a function, many benchmark functions were created [16].

In the design of very efficient structures, GOAs, gradient-based, and other optimization algorithms are applied in conjunction with mathematical models of the structures. Since the computation costs of the structural models are often expensive, metamodels are often applied. If the structural model is an aeronautical or spatial structure, aerodynamics models, which also are computationally expensive, are added to the structural model in a so-called multidisciplinary design optimization (MDO).

In the field of AI, Rumelhart et al. described the backpropagation method [17], which is applied to train multi-level ANNs. These ANNs are a type of metamodel, which consists of a mathematical model which mimics the flow of information observed in organic neuronal tissues of several living species, which allows many living organisms to have intelligence. This methodology has been very efficient in text, image, and speech recognition, among other applications. Among some of its generalized applications, ANNs can be applied to forecast the response of a mathematical function, and category classification.

Deep learning (DL) [18], is a technique created by Lecun, Bengio, and Hinton, where many layers of ANNs are trained over data set to recognize several levels of patterns. It has unsupervised training, different than ANNs, and has many important applications for the automation of many complex and challenging tasks, substituting human work in many fields of activity with similar or greater levels of intelligence. DL and other areas of AI have as their basic building blocks response surfaces such as ANNs, KR among others metamodels. Since usual AI tasks involve large data sets, large metamodels are required, which require elevated training times. This demands large parallel computing infrastructure for their often computationally very expensive metamodel training procedures.

Some mathematical models such as the finite element model (FEM) are applied to model the behavior of structures and other systems, like the pressure of airflow over the wing of an airplane, the magnetic field of an electrical component, etc. . . . . Yet these models require the generation of a mesh, which oftentimes is very complex and laborious, thus mesh generation is often treated as a subject of research itself.

### BRIEF SUMMARY OF THE INVENTION

The NRM is a niching, or MMO algorithm which identifies a set of the most efficient solutions instead of the overall population of solutions, as other niching methods, facilitating the design process in avoiding the verification of a large number of design variations. It also provides an equalized multi-focus exploration effort on each identified niche, properly exploring the most suitable evaluated niches before providing a final response.

Another application of the NRM is the segmentation of the domain of any function with any type of distribution, such as clustered, random or Cartesian. Thus, the NRM can be applied to generate a mesh for a FEM or to segment the domain of response surfaces, such as artificial neural networks (ANNs), Kriging (KR) models, among others.

With a response surface mesh, the expensive training times of metamodels can be significantly reduced by parallelization and simplification of the models. In addition, individual response surface elements can be updated individually.

A simplified overview of the NRM is provided:

### Niche Ranking Method—Phase 1 (NRM-1)

1: Sort the population of solutions Pop by objective value, with the best objective value at first.
2: Calculate the normalized distance matrix Z of sorted Pop.
3: To each solution i, starting with the solutions with the best objective value, verify if there is a niche leader j with a better objective value than i, within a d₁ radius of solution i.
4: If solution i is inside a recorded niche, then record which niche it belongs to.
5: If solution i is not inside a recorded niche and the number of identified niche leaders is lower than the maximum number of allowed leaders Nₗ, then solution i is also a niche leader.
6: Else, if the number of maximum niche leaders is reached, then solution i belongs to the niche of the closes niche leader.

The NRM can also be applied with a higher neighbor niche propagation, which expands and identifies all the most interesting niches of a function, with a sufficiently populated domain. This variation, NRM with higher neighbor niche propagation (NRM-b), can be applied by substituting lines 3 and 4 of algorithm 1 by:

3: To each solution i, starting with the solutions with the best objective value, verify if there is a solution j with a better objective value than i, within a d₁ radius of solution i.
4: If solution i is closer to solution j, then the niche of i is the same as the niche of j.

The default NRM is indicated for an isometric mesh generation, and for some specific algorithm combinations, like swarm methods. The NRM-b is indicated to identify all local optima of a function, and for combinations with algorithms that perform permutation. With this, it is necessary to evaluate the redundancy penalty and niche rank of each point, as described in Algorithm 2, of NRM-phase 2:

### Niche Ranking Method—Phase 2 (NRM-2)

1: To each solution i, verify if there is a solution j that has the best and greater objective value than solution i and is within the redundancy radius d₂.
2: If there is a solution j, add 1 to the number of replicates of j.
3: The Redundancy Penalty of solution i is then defined by the number of replicates of solution j with a better objective value than solution i, which surpasses the number of allowed replicates Nᵣ.
4: The Niche Rank of solution i is given by the number of solutions of the same niche which have better objective value and are not penalized with redundancy.
5: Generate the rank vector: [Redundancy Penalty, Niche Rank, Objective Value] and sort the population of solutions.

### BRIEF DESCRIPTION OF THE DRAWINGS

FIG. 1 illustrates the regular objective value sorting of solutions in a population-based optimization algorithm.

FIG. 2 illustrates the niche ranking sorting in a population-based optimization algorithm.

FIG. 3 displays the side view of the cantilever beam structure.

FIG. 4 displays the mesh of the FEM of the optimized structure.

FIG. 5 illustrates the 2D profile of the optimized structures, displaying all the four niche leaders in bold lines, and each niche sub solutions in dashed lines.

FIG. 6 illustrates the design polygons of the optimized structures, displaying all the four niche leaders in bold lines, and each niche sub solutions in dashed lines.

### DETAILED DESCRIPTION OF THE INVENTION

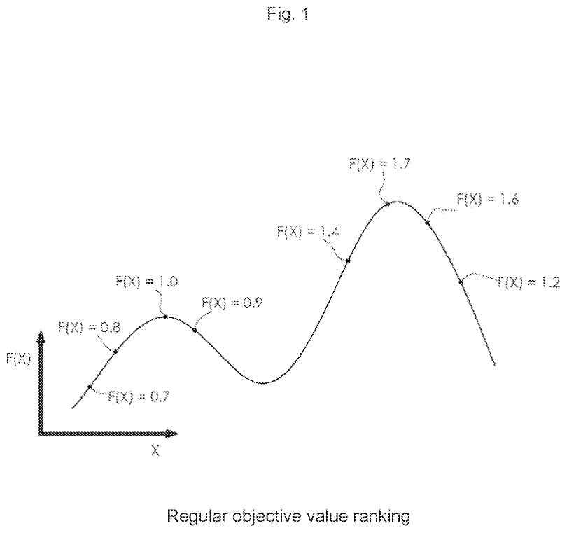

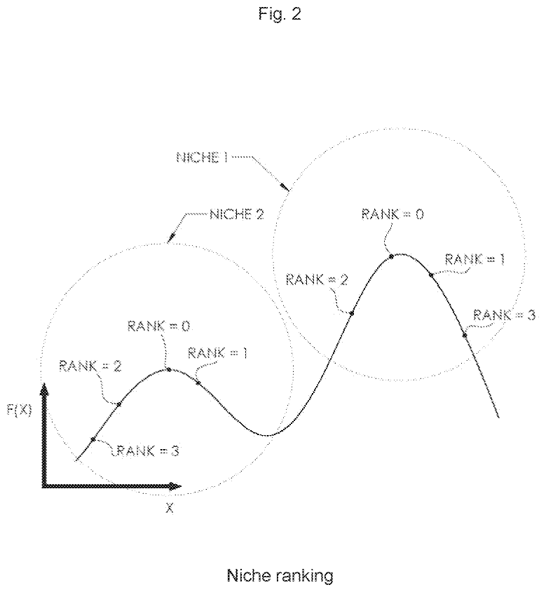

The NRM evaluates the solutions of a population-based GOA, in order to explore in parallel the most interesting regions of the design space. FIG. 1 displays the regular objective value ranking, used for the objective value sorting, as the usual sorting procedure of most GOAs. FIG. 2, in contrast, displays the niche ranking, which is part of the NRM algorithm.

For the NRM to operate, the design space must be normalized, where each design variable is defined between zero and one. Once each solution is evaluated by the single objective value, the population of solutions is sorted by the objective value, having the solution with the best objective value at first. With a normalized optimization space, is possible to calculate the distance matrix D between each solution of the sorted population.

Assuming a normalized optimization space with H dimensions can be represented by a hypercube, the size of the greatest diagonal inside this hypercube L is given as the square root of H. To have all distances in the optimization space between 0 and 1, the normalized distance matrix Z is defined as the distance matrix D divided by the size of the greatest diagonal of the design space hyper-cube L.

In NRM, the niche leader is a solution with the best objective value within the niche, and a sub solution is a point that is not a leader. Each niche leader receives a niche rank equal to zero, and each sub solution receives the niche rank equal to the number of solutions non-penalized for redundancy in the same niche, which have better objective value. Four operational variables are defined: the niche radius d₁, the redundancy radius d₂, the number of allowed replicates Nᵣ, and the number of allowed niche leaders Nₗ.

If a solution does not have another niche leader with better objective value within a distance smaller than d₁, it can potentially be a niche leader. If the number of niche leaders already identified by the algorithm is lower than the maximum number of allowed leaders Nₗ, this solution is also considered a niche leader. Since there are limited allowed leaders, exceeding leader candidates are defined as a sub solution of the closest leader recorded by the algorithm.

Following this, it is necessary to define the redundancy penalty of each solution. If two solutions have their distance smaller than the redundancy radius d₂, then the solution with a worse objective value has its redundancy penalty increased by one. In order to allow intensive localized exploration, a number of allowed replicates, Nᵣ are allowed to each solution and are not penalized for redundancy.

Once each point has its redundancy penalty and niche rank evaluated, a rank vector with three variables is generated, with the following sequence: redundancy penalty, niche rank, and objective value. With this, in the NRM sorting, the candidate solutions are sorted by the first rank variable, and then for identical values in the first variable, the second variable is the sorting parameter. The same rule is applied for the third rank variable, and thus the sorting process is accomplished. This will prioritize non-redundant solutions in competitive regions of the design space, with the best objective values, promoting an equal number of solutions on each niche.

The NRM is presented for a minimization task, at algorithms 1 and 2.

```
Algorithm 1: Niche Ranking Method-Phase 1 (NRM-1)
  1: procedure NRM-1(Pop, iter, par)
  2: Sort the population of solutions Pop by objective value,
    with best objective value at first
  3: Calculate the normalized distance matrix Z of sorted Pop
  4: NicheLeadersCount ← 0
  5: NicheLeadersList ← [ ]
  6: Reset all NRM variables
  7: for i = 1 to par.PopSize do
  8:  PointDefined ← 0
  9:  (verify if the point is close to a recorded niche leader)
10:  for j = NicheLeadersList do
11:  if Z(i,j) <= par.d1 do
12:  PointDefined ← 1
13:  Pop(i).Niche ← Pop(j).Niche
14:  Pop(i).IsNicheLeader ← 0
15:  break for loop
16:  end if
17:  end for
18:  (if it is not close to a niche then it can be a niche leader)
19:  if PointDefined = 0 do
20:  if NicheLeadersCount < par.MaxNicheLeadersCount do
21:  NicheLeadersCount ← NicheLeadersCount + 1
22:  NicheLeadersList ← [NicheLeaderList, i]
23:  Pop(i).Niche = NicheLeadersCount
24:  Pop(i).IsNicheLeader ← 1
25:  (if niche leaders list is full, select closer leader)
26:  else if NicheLeadersCount >= par.MaxNicheLeadersCount do
27:  SmallerDistance ← inf
28:  for j = NicheLeadersList do
29:  if Z(i,j) < SmallerDistance do
30:  CloserNicheLeader ← j
31:  SmallerDistance ← Z(i,j)
32:  end if
33:  end for
34:  Pop(i).Niche ← Pop(CloseNicheLeader).Niche
35:  Pop(i).IsNicheLeader ← 0
36:  end if
37:  end if
38: end for
39:
```

It is important to note that, to promote a greater number of niche distribution, a variation of the NRM with a propagated upper neighbor niche (NRMb), Line 1o of Algorithm 1 can be substituted by:

for j=1: i−1 do

Thus, with the extended niche propagation, all the local optima will be identified, if the number of allowed apices is unlimited and the domain is sufficiently populated. The NRM-b has demonstrated poorer efficiency for PSO combinations, and greater efficiency for evolutionary algorithms which perform mutation and permutation. The default NRM allows also an isometric mesh generation for any domain with any number of coordinates or type of distribution, such as Cartesian, clustered or random.

With Algorithm 1 defined, it is necessary to evaluate the redundancy penalty and niche rank of each point, as described at algorithm 2, of NRM phase 2:

```
Algorithm 2: Niche Ranking Method-Phase 2 (NRM-2)
  1: procedure NRM-2(Pop, iter, par)
  2: (define redundancy level of each solution)
  3: for i = 1 to par.PopSize do
  4:  for j = 1 to i-1 do
  5:  if Z(i,j) < par.d2 do
  6:  Pop(j).ReplicasQty ← Pop(j).ReplicasQty + 1
  7:  DeltaRedundacy ← Pop(j).ReplicasQty − par.AllowedReplicates
  8:  Pop(i).RedundacyPenalty ← max(0, DeltaRedundacy)
  9:  Break loop
10:  end if
11:  end for
12: end for
13: RegionCount ← reset
14: (define the niche rank for each solution)
15: for i = 1 to par.PopSize do
16:  Niche ← Pop(i).Niche
17:  Pop(i).NicheRank ← RegionCount(Niche)
18:  if Pop(i).RedundacyPenalty = 0 do
19:  RegionCount(Niche) ← RegionCount(Niche) + 1
20:  end if
21: end for
22: for i = 1 to par.PopSize do (write ranks and sort)
23:  Pop(i).Rank(1) ← Pop(i).RedundacyPenalty
24:  Pop(i).Rank(2) ← Pop(i).NicheRank
25:  Pop(i).Rank(3) ← Pop(i).ObjectiValue
26: end for
27: Sort Pop by rank 1 to 3 and select the best solution
```

It is important to note that the algorithm is configurated for minimization tasks. For a maximization task, the sorting at line 2 of algorithm 1 should have the greater objective value at first, and the objective value at line 25 of algorithm 2 must be multiplied by −1.

The normalized distance calculation formula is based on the Euclidean distance between two points, divided by the length of the greater diagonal of the normalized design with N dimensions. Thus the Z matrix formulation is defined:

$$Z ( i , j ) = \frac{Dist ( i , j )}{\sqrt{N}} \qquad ( eq . 1 )$$

An option to reduce computation costs is to only calculate distances as required by the algorithm and store the calculated values.

In order to define the operational parameters of the NRM and the population size, it is important to evaluate the maximum number of possible niches in the design space, and calculate which fraction of the domain is to be considered in the optimization.

If we call t any positive integer close to x, were:

t<x<t+1

We define the ceil function as:

ceil(x)=t+1 (eq. 2)

In a given space with H dimensions, the number of possible niches is given by the number of possible hyper-cubical subspaces which can fit in the design space, which is an approximation for the hyper-spherical sub-regions. The number of intersecting niches that can fit in one dimension, N, is given by the normalized length divided by the radius of the hyper-sphere of the niche. Since in the algorithm all distances are divided by the length of the greater diagonal, the radius of the hyper-sphere is multiplied by the square root of H. Thus, we have:

$$N = ceil ( \frac{1}{{d}_{1} \sqrt{H}} ) \qquad ( eq . 3 )$$

If we call b the approximate quantity of possible niches in the overall design space, we have:

b=N^{H} (eq. 4)

With this, it is convenient to define the niche radius d₁, the redundancy radius d₂ and the number of allowed leaders Nₗ in the design space, according to the population size and the fraction of the domain expected to be explored in the optimization. The number of solutions per niche Nₛₙ must be enough to allow an appropriate localized exploration, and is defined by the size of the population of solutions Nₚ in the overall design space divided by the number of niches, which is given by the number of allowed leaders Nₗ:

Nₛₙ=Nₚ/Nₗ (eq. 5)

It is interesting to assure that on each niche, the solutions would not concentrate near the apex, but rather would have a broad distribution, which is achieved with the redundancy penalty. However, if the solutions are too dispersed inside each niche, intensive numerical exploration could be compromised. Therefore, it is necessary to define an allowed number of replicates Nᵣ for each optimization case. If Nᵣ is too low, the solutions can be too dispersed inside each niche, and if is too high, would be too concentrated, limiting a broader exploration. Experimental results with test functions defined optimal parameter configuration for d₁ equal to 0.2, d₂ equal to 0.01 and Nᵣ as 4. Nₗ can be defined as required, observing the population size.

The NRM can be applied to sort a population of solutions favoring an equal distribution on each considered niche of the design space. For this, the GOA working with the NRM sorting must be operating with aggregated population like occurs for example in the GA. In the GA, the operators of mutation and crossover are applied to an existing population POP_P, and thus another population, POP_Q, is generated. After POP_Q has its objective values defined, the two populations are added (aggregated), generating POP_R. This population POP_R, in the original configuration of the GA, is then sorted according to the single objective value, and the best solutions are kept, generating POP_P of the following iteration.

The NRM can be applied by substituting the regular objective value sorting with the NRM sorting, favoring a local optima distribution, as illustrated in FIG. 2. This sorting with the NRM is called niche ranking population sorting process (NRPS).

Some algorithms do not work with aggregated populations, but rather work with ameliorated populations, which is the case of simulated annealing and PSO. In these algorithms, the population POP_P of the following generation is made of some solutions of the existing POP_P population and some solutions of the POP_Q population, by following the particular selection process of each method. This does not allow the NRPS process to be applied, therefore to apply a niche rank sorting it is necessary to modify these algorithms to work with aggregated populations. Thus, it is generated a larger POP_R population which can then be sorted by the NRPS, and generate the population POP_P of the following generation with a niche ranking distribution.

The NRM can be combined with other algorithms in many ways. In swarm algorithms like the PSO, the niche leader can substitute the global best vector, generating several local swarms. In evolutionary methods, permutation can be applied only inside the same niche.

For the purpose of illustration, it is described how the NRM can efficiently explore efficiency and diversity in the design optimization of a metallic cantilever beam, identifying the four most distinct and efficient design solutions of the overall population of solutions.

The second example showcases how the NRM-b can segment a response surface and significantly reduce its overall computation time related to training.

The NRM can also be applied for mesh generation for a domain with any number of coordinates and type of input distribution. Once the niche leaders and the niches sub spaces are identified by the NRM-1, the polarization vertex (PV) of each niche are defined as the average position of its inputs. Once each PV is located, each polarized mesh element (PME) is defined by the points of the domain which are closer its PV. The size of each PME is can be adjusted by the niche radius d₁. Since the niche radius can be defined as a function of the objective value of the niche leader, or its position in the design space, the mesh resolution can be adjusted to greater precision in regions of interest. In order to avoid having PMEs sub populated for response surfaces, and increase the precision on each element, each response surface element is defined by the points which have distance with the PV less than d₁, or as the distance of the furthest point of the niche from the PV.

### Application Example 1: Structural Optimization

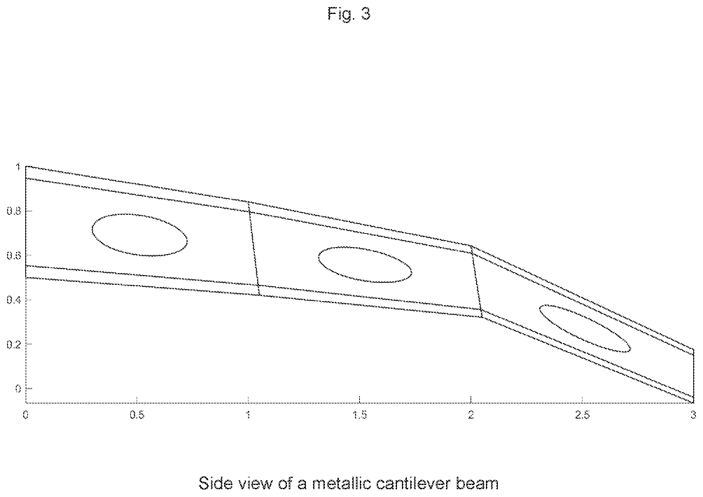

In order to demonstrate the multi-focus optimization capacity of the NRM, the algorithm is applied in the optimization of a metallic cantilever beam. This cantilever beam is a stabilizing leg of a spacecraft made of aluminum, composed of three sections made of an “I” profile with a hole in the center, where the design configuration of each section can vary under certain limits. A side view of the cantilever beam with the default design configuration, where all design variables are equal to 0.5, is presented in FIG. 3. The double line at the top and the bottom of each section of the structure are related to the position of the flange of the “I” beam, and the distance between each parallel double line represents the thickness of the flange, which can also vary. The structure parts related to the connection with the spacecraft and the foot of the stabilizing leg are not considered in the 2D FEM analysis, therefore only the central section of the structure is modeled. The total height of the structure is about 1 meter, and it must have limited deformations under loading over its 3 meters length.

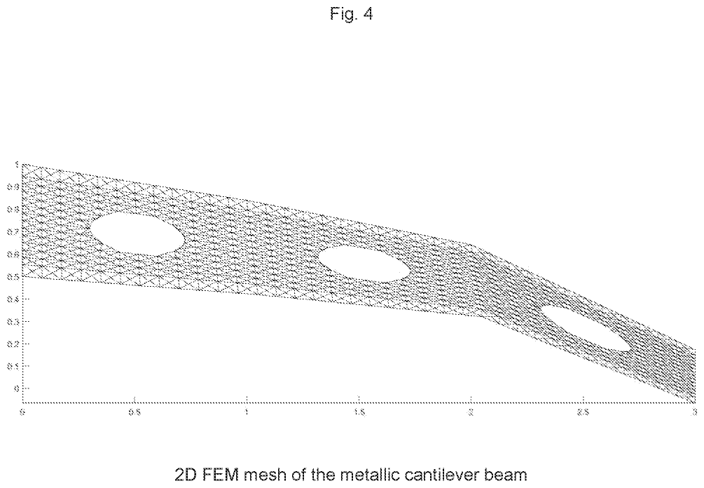

In order to calculate the deformations and tensions of the beam, a 2D FEM model with triangular element mesh was generated, as displayed in FIG. 4. The material coefficients used for the model are from the aluminum alloy 2024-T4.

As boundary conditions, the beam is fixed on the left side, and a vertical load is placed on the right side of the structure. Under these conditions, the structure must have all nodal displacements limited to a maximum allowed value of 0.05 m. Along all the structure it is necessary to maintain Von Misses principal tension σ₁ lower than the maximum tension allowed, 300 MPa.

For this optimization task, a combination of GA with the NRM is selected, where cross-over operations are applied only between solutions of the same niche, and the population of solutions sorting follows the NRM sorting process. The operational parameters are 0.1 for d₁, 0.05 for d₂, 4 allowed niche leaders, and 2 allowed replicates. The goal of the optimization is to generate a diverse set of very efficient design configurations which minimizes the overall structural weight while maintaining deformations and maximum tensions under defined values. In FIGS. 1 and 2, it is seen how the NRM algorithm can explore in parallel multiple local optima of a given function. Thus, similarly, the NRM algorithm is in this experiment applied for structural optimization, to generate a set of multiple local optima design configurations for the beam, providing both efficiency and diversity for a single objective optimization.

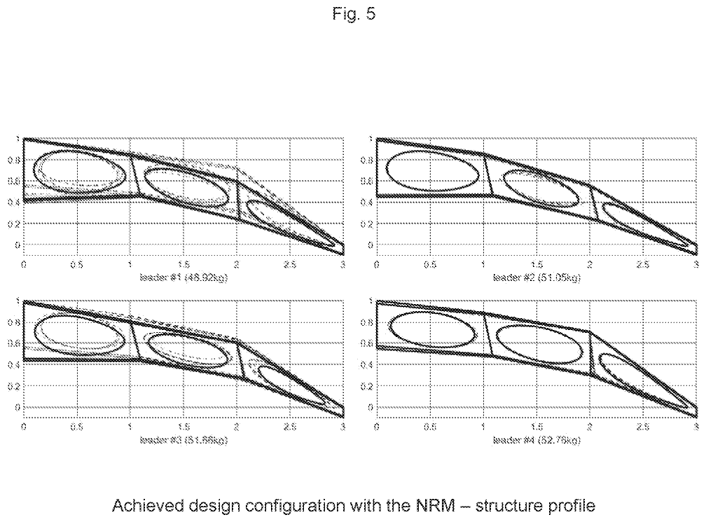

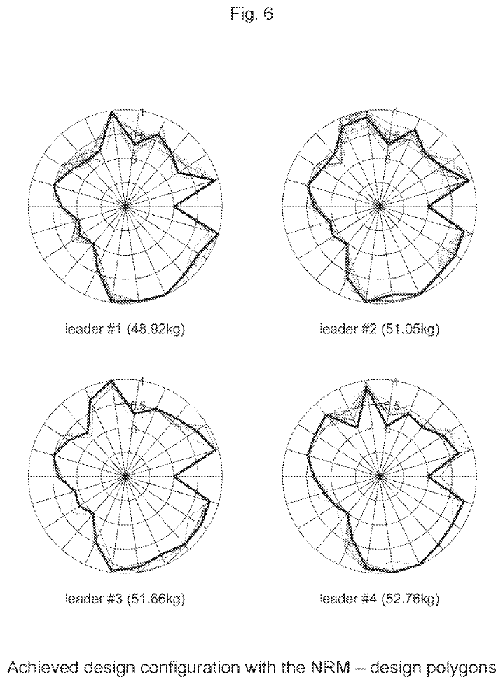

The outline of the achieved design configurations in this optimization study are displayed in FIG. 5. The apices of the 4 local regions achieved represent 4 main design configurations, which are presented in bold lines, while the sub solutions of each 4 local optima are presented with a thinner line. The best design solution achieved is apex 1 with 48.92 kg as the objective value. Very close to this value are apex 2, 3, and 4 with 51.05 kg, 51.66 kg, and 52.76 kg respectively. FIG. 6 displays the design polygons of the achieved design configurations.

The solutions profiles displayed in bold black line are the best local optima configurations, the niche leaders of each local optima, which are the 4 most competitive solutions in terms of weight efficiency while having significant distance between each other in the design space. This distance between each leader is of at least d₁ in the normalized design space, which translates into different design configurations for the structure. This illustrates that a single optimization study using a GOA combined with the NRM algorithm can generate distinct local apices designs with competitive performance, and several sub solutions. It is also interesting to note that this algorithm identified the four most interesting solutions which are the most efficient solution in its niche, differing from the operation of most niching algorithms which provide as output the overall population of solutions. As the results demonstrate, it is expected that the NRM can provide important contributions to several design processes of single objective optimizations.

### Application Example 2: Metamodel Segmentation

In order to compare the efficiency of segmented and non-segmented response surfaces, several benchmark functions used for this purpose are selected [16]. The metamodel applied in this experiment is the model called Kriging (KR), also called Gauss Process, which is a popular metamodel in AI and optimization used to forecast the output of a function. Each function has its 2D domain defined in a Cartesian grid of 71×71 points, and the error of the output and other performance parameters are presented. Tables 1 to 4 display the comparison in terms of performance of the metamodel and time delayed on training. The metrics for metamodel performance measurement are the average error and variance of the error. Other metrics to measure the performance of metamodels are also applied, which are R square, RMAE, and RAAE, as described by Mahdi et al. [20]. It is important to note that for the response surface mesh (RSM), each element of the metamodel was training in parallel computing using a dual-core computer, and the overall training time includes the mesh generation. The kriging with response surface mesh approach (RSM-KR) has its performance compared with the regular KR application for four functions:

TABLE 1
Performance comparison for the Ackley function
Ackley function

| response surface | KR | RSM-KR |
|---|---|---|
| n segments | 1 | 130 |
| total training time | 7 min 14.8 sec | 10.98 sec |
| mean_error | 4.537e−01 | 1.397e−03 |
| variance | 3.258e−01 | 8.733e−05 |
| r square | 9.968e−01 | 1.000e+00 |
| raae | 4.502e−02 | 1.385e−04 |
| rmae | 2.737e−01 | 4.036e−02 |

TABLE 2
Performance comparison for the Beale function
Beale function

| response surface | KR | RSM-KR1 |
|---|---|---|
| n segments | 1 | 222 |
| total training time | 20 min 3.88 sec | 12.62 sec |
| mean_error | 2.080e−01 | 1.732e−01 |
| variance | 9.528e−02 | 1.765e−01 |
| r square | 1.000e+00 | 1.000e+00 |
| raae | 1.615e−04 | 1.345e−04 |
| rmae | 3.026e−03 | 3.710e−03 |

TABLE 3
Performance comparison for the Booth function
Booth function

| response surface | KR | RSM-KR |
|---|---|---|
| n segments | 1 | 225 |
| total training time | 27 min 1.21 sec | 12.81 sec |
| mean_error | 4.827e−02 | 1.722e−01 |
| variance | 3,659e−03 | 1.746e−01 |
| r square | 1.000e+00 | 1.000e+00 |
| raae | 7.777e−05 | 2.775e−04 |
| rrnae | 3.538e−04 | 4.543e−03 |

TABLE 4
Performance comparison for the Custom
Probability Density Function
Custom probability density function

| response surface | KR | RSM-KR |
|---|---|---|
| n segments | 1 | 209 |
| total training time | 15 min 6.51 sec | 12.47 sec |
| mean_error | 1.640e−04 | 1.913e−04 |
| variance | 1.476e−07 | 9.837e−08 |
| r square | 1.000e+00 | 1.000e+00 |
| raae | 8.192e−04 | 9.557e−04 |
| rmae | 1.238e−02 | 1.290e−02 |

From table 1 to 4 is possible to see that the training time of the KR model, which ranged from 27 to 7 minutes, was significantly reduced with the generation of the RSM with the NRM. The RSM-KR presented a total computation time of about 11 to 13 seconds, a time reduction up to more than 120 times. These results were achieved with niche generation with d₁ equal to 0.1, and overlapping PMEs, with overlap radius set as d₁ from the PV.

Experiments have demonstrated that for a domain with an increased number of inputs, the training time for the non-segmented model can achieve many hours, while the segmented mesh remains less than 20 seconds for the tested cases. Also, it is noted that there is not much difference in terms of the precision of the RSM, which demonstrates that the RSM is an important alternative to reduce computation costs of metamodels.

### Definitions

A. Niche—A subspace of the domain of a function which encompass solutions which share similitude. A niche often encompasses solutions with competitive output.
B. Niche leader—The best solution inside a niche.
C. Sub solution—Any solution which is not a niche leader.

FIG. 1—Regular objective value ranking of solutions

FIG. 1 illustrates how a population of solutions are ranked in the regular objective value sorting.

FIG. 2—Niche ranking of solutions

FIG. 2 illustrates how a population of solutions are ranked in the niche ranking sorting.

FIG. 3—Side view of a cantilever beam structure, units in meters.

FIG. 3 illustrates the side view of the default design configuration of the cantilever beam with an “I” profile, and holes to reduce weight. The cantilever beam is segmented in three sections.

FIG. 4—The 2D FEM mesh of the cantilever beam structure

FIG. 4 displays the 2D finite element mesh of the cantilever beam illustrated in FIG. 3.

FIG. 5—Optimization results—2D side view of the structure of the four niche leaders design configurations and sub solutions.

FIG. 5 illustrates the optimization results. It is illustrated the four niche leaders of the multimodal optimization, with multiple efficient and distinct design configuration. Niche leaders are illustrated in bold lines, while the sub solutions of each niche are illustrated with a thinner line.

FIG. 6—Optimization results—Design polynomial of the four niche leaders design configurations and sub solutions.

FIG. 6 illustrates the optimization results in graphical analysis of the design polygons. It is illustrated the four niche leaders of the multimodal optimization, with multiple efficient and distinct design configuration. Niche leaders are illustrated in bold lines, while the sub solutions of each niche are illustrated with a thinner line.

### REFERENCES

[1] D. Goldberg, “Genetic Algorithms in Search, Optimization and Machine Learning,” Addison-Wesley Prof, 1989.
[2] J. Kennedy and R. Eberhart, “Particle Swarm Optimization,” Proc. IEEE Int. Conf. Neural Networks, pp. 1942-1948, 1995.
[3] R. Storn and K. Price, “Differential Evolution—A Simple and Efficient Heuristic for global Optimization over Continuous Spaces,” J. Glob. Optim., vol. 11, no. 4, pp. 341-359, 1997, doi: 10.1023/A:1008202821328.
[4] T. H. A. Scollen, “Simulated Annleaing, Introduction, Application and Theory,” Nove Sci. Publ. Inc. New York, 2018.
[5] A. H. Gandomi, X.-S. Yang, and A. H. Alavi, “Cuckoo search algorithm: a metaheuristic approach to solve structural optimization problems,” Eng. Comput., vol. 29, no. 1, pp. 17-35, 2013, doi: 10.1007/s00366-011-0241-y.
[6] J. H. Holland, Adaptation in Natural and Artificial Systems. Ann Arbor, Mich.: Univ. of Michigan Press, 1975.
[7] D. E. Goldberg and J. Richardson, “Genetic algorithms with sharing for multimodal function optimization,” Proc. of the Second Int. Conf. Genet. Algorithms, pp. 41-49, 1987.
[8] G. R. Harik, “Finding multimodal solutions using restricted tournament selection,” Proc. Sixth Int. Conf. Genet. Algorithms, 1995, [Online]. Available: citeseer.ist.psu.edu/.
[9] S. W. Mahfoud, “Crowding and preselection revisited,” Parallel Probl. solving from Nat. 2, 1992, [Online]. Available: citeseer.ist.psu.edu/mahfoud92crowding.html.
[10] K. A. De Jong, “An Analysis of the Behavior of a Class of Genetic Adaptive Systems.,” University of Michigan, USA, 1975.
[11] D. Beasley, D. R. Bull, and R. R. Martin, “A sequential niche technique for multimodal function optimization,” Evol. Comput., 1993, [Online]. Available: citeseer.ist.psu.edu/beasley93sequential.html.
[12] M. Bessaou, A. Petrowski, and P. Siarry, “Island Model Cooperating with Speciation for Multimodal Optimization,” Springer Berlin Heidelb., 2000.
[13] X. Yin and N. Germay, “A fast genetic algorithm with sharing scheme using cluster analysis methods in multi-modal function optimization,” Int. Conf. Artif. Neural Networks Genet. Algorithms, pp. 450-457, 1993.
[14] C. E. Rasmussen, “Gaussian Processes in Machine Learning,” in Advanced Lectures on Machine Learning: ML Summer Schools 2003, Canberra, Australia, Feb. 2-14, 2003, Tübingen, Germany, Aug. 4-16, 2003, Revised Lectures, O. Bousquet, U. von Luxburg, and G. Ratsch, Eds. Berlin, Heidelberg: Springer Berlin Heidelberg, 2004, pp. 63-71.
[15] R. Jin, W. Chen, and T. W. Simpson, “Comparative studies of metamodeling techniques under multiple modeling criteria,” 8th Symp. Multidiscip. Anal. Optim., 2000, doi: 10.2514/6.2000-4801.
[16] C. Bogoclu and D. Roos, “A benchmark of contemporary metamodeling algorithms,” ECCOMAS Congr. 2016 —Proc. 7th Eur. Congr. Comput. Methods Appl. Sci. Eng., vol. 2, no. June, pp. 3344-3360, 2016, doi: 10.7712/100016.2039.7645.
[17] D. E. Rumelhart, G. E. Hinton, and R. J. Williams, “Learning representations by back-propagating errors,” Nature, vol. 323, no. 6088, pp. 533-536, 1986, doi: 10.1038/323533a0.
[18] Y. Lecun, Y. Bengio, and G. Hinton, “Deep learning,” Nature, vol. 521, no. 7553. Nature Publishing Group, pp. 436-444, May 2015, doi: 10.1038/nature14539.

What is claimed is:

1. The niche ranking method (NRM) comprises an algorithm which:
a) Ranks a population of solutions according to its objective value within its delimited subspace called niche.
b) Ranks a population of solutions according to its objective value within its delimited subspace called a niche, and a non-redundancy factor.
c) Ranks a population of solutions according to its objective value within its delimited subspace called a niche, and another variable or set of variables.

2. The NRM comprises an algorithm that identifies which solutions belong to each niche, by:
a) Identifying which solutions are inside the hypersphere region of N-dimensions, delimited by the radius d₁, centered with the niche leader.
b) Identifying which solutions belong to each niche by a higher neighbor niche propagation, defined by the following steps i and ii:
i. Sorting a population of solutions with the best objective value at first.
ii. Staring with the solution with the best objective value, if solution B is closer than the niche radius d₁ to solution A, where A has a better objective value than B, then the niche of B is the same as the niche of A.

3. The NRM comprises an algorithm that has a niche radius d₁, which can be defined as a constant value along all the design space, or d₁ can be defined as a function of the position of the niche leader, or its objective value.
